(19) United States
(12) Patent Application Publication
(10) Pub. No.: US 2010/0174611 A1
(43) Pub. Date: Jul. 8, 2010

(54) Method for improving financial transaction security

(76) Inventors: David S. Benco, Winfield, IL (US); Robin R. Schmuckal, Naperville, IL (US)

Correspondence Address: Alcatel - Lucent USA Inc.;Docket Administrator - Room 2F-192, 600-700 Mountain Avenue, Murray Hill, NJ, 07974, US

(21) Appl. No.: 12/319,384

(22) Filed: Jan. 7, 2009

(51) Int. Cl. G06Q 20/00; H04W 4/12

(52) U.S. Cl. 705/16; 705/35; 455/466

(57) ABSTRACT

Methods are disclosed for performing cardholder verification associated with a customer card transaction through use of code sequences delivered independently to a point of sale terminal and to a customer unit (e.g., mobile phone). A point of sale terminal initiates a customer card transaction by sending a card number to a customer card processing system. An application server receives the card number and generates a code sequence corresponding to the transaction. The application server sends a first instance of the code sequence to the point of sale terminal and a second instance of the code sequence to the customer unit associated with the card number. Authorization status of the transaction is thereafter determined by an operator of the point of sale terminal comparing the first and second instances of the code sequence.

### FIELD OF THE INVENTION

This invention relates generally to a communication system supporting cardholder verification services (e.g., relating to credit card purchases and variations thereof).

### BACKGROUND OF THE INVENTION

Credit cards (and variations thereof including debit cards, charge cards and the like) are well-known devices for presenting payment associated with financial transactions in lieu of cash payment or personal checks. The credit card industry is very successful and well-established worldwide. However, a major problem in the credit card industry is the prevalence of credit card fraud. Credit card fraud may be accomplished, for example, by unauthorized persons obtaining access to credit cards or their information (e.g., credit card number, cardholder name, expiration date, 3-digit security code) and using the information to accomplish a fraudulent purchase. A related problem is that many credit card transactions are accomplished remotely via the telephone or the web, without requiring physical access to the card and without requiring physical identification of the user, thereby furthering instances of credit card fraud. Although credit card issuing institutions absorb the direct cost of fraud, the costs are ultimately passed on to merchants and card holders in higher fees, interest rates or the like. Accordingly, there is a continuing need for enhanced or additional security measures to reduce instances of credit card fraud.

### SUMMARY OF THE INVENTION

These problems are addressed and a technical advance is achieved in the art by a cardholder verification service (e.g., relating to credit card purchases and variations thereof) utilizing mobile phones, PDAs or the like to provide enhanced or additional security to reduce instances of fraud. The cardholder verification service described herein can be accomplished independently (or optionally, supplementary) to physical verification methods, and can be implemented with minimal inconvenience to the credit card holder for transactions including, without limitation, in-store transactions, telephone or web-based transactions.

In one embodiment, there is provided a method, carried out by a customer unit, for purpose of cardholder verification associated with a customer card transaction. The customer unit receives a code sequence corresponding to the customer card transaction and uses the code sequence for cardholder verification, whereby the customer unit code sequence is compared to a code sequence received independently by a point of sale terminal to determine an authorization status of the transaction.

In another embodiment, there is provided a cardholder verification method associated with a customer card transaction performed by an operator of a point of sale terminal. The operator of the point of sale terminal receives from a customer card processing system a first instance of code sequence corresponding to the customer card transaction; and from a customer unit a second instance of code sequence corresponding to the customer card transaction. The operator compares the first and second instance of code sequence to determine an authorization status of the transaction.

In still another embodiment, there is provided a method of supporting cardholder verification associated with a customer card transaction, wherein an application server receives a card number associated with a customer card transaction and generates a corresponding code sequence. The application server sends a first instance of the code sequence to a point of sale terminal and a second instance of the code sequence to a customer unit associated with the card number. Authorization status of the transaction is thereafter determined by an operator of the point of sale terminal comparing the first and second instances of the code sequence.

### BRIEF DESCRIPTION OF THE DRAWINGS

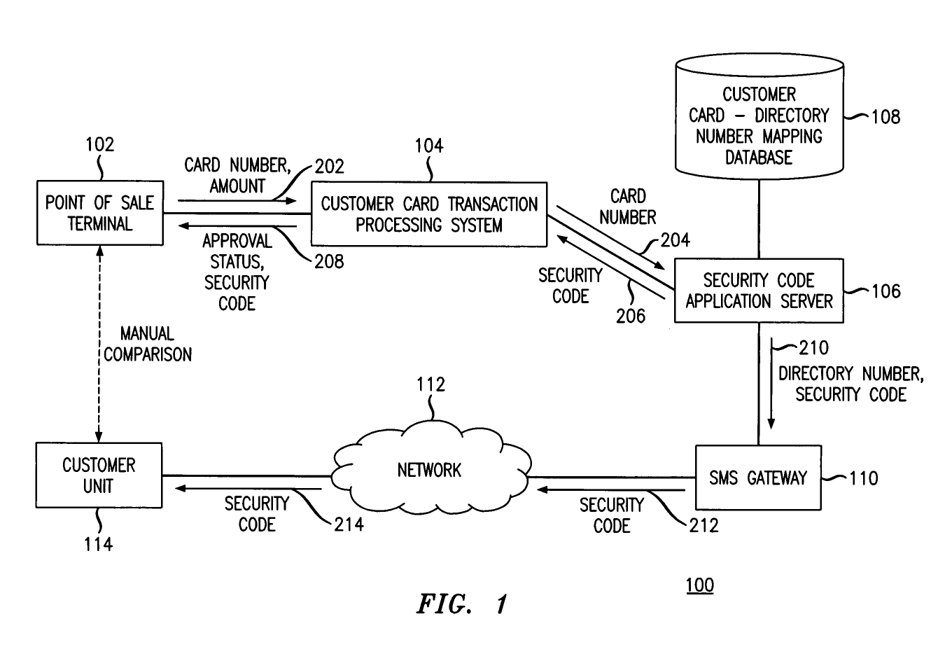

The foregoing and other advantages of the invention will become apparent upon reading the following detailed description and upon reference to the single FIG. 1, which illustrates a communication system and exemplary message flow associated with a cardholder verification service according to an embodiment of the invention.

### DESCRIPTION OF THE PREFERRED EMBODIMENT(S)

FIG. 1 shows a communication system 100 according to an exemplary embodiment of the invention that supports a cardholder verification service (e.g., relating to credit card transactions and variations thereof). For convenience, the term “customer card” shall refer hereinafter to credit cards and their variations including, without limitation, debit cards and charge cards. The term “customer card transactions” shall be understood to include, without limitation, in-store transactions, telephone or web-based (“e-commerce”) transactions using credit cards or their variations.

The communication system 100 includes a point of sale terminal 102, customer card transaction processing system 104, security code application server 106, customer card-directory number mapping database 108, SMS gateway 10, network 112 and customer unit 114. The elements of the communication system are functional elements that may be implemented in one or more physical devices; and are connected by logical links that may be physically realized, without limitation, by conventional subscriber lines, Asynchronous Transfer Mode (ATM) lines, ISDN lines, Ethernet LAN or WAN, wireless links, and the like.

The point of sale terminal 102 comprises, for example and without limitation, a customer card payment terminal, networked computer terminal or other suitable network node equipped with application software for processing customer purchases. In the case of an in-store transaction, the point of sale terminal 102 is typically associated with a sales clerk who interfaces with the customer to identify and price various items presented for purchase, and to receive and inspect the customer card coincident to the prospective purchase. The clerk may request the customer to show a driver's license or other identification in attempt to ascertain the customer's name/identity and to compare to the cardholder name. In the case of a telephone or web-based transactions, the point of sale terminal 102 may or may not include a human operator but in any case is generally not equipped to physically receive the card or physically ascertain the identity of the customer.

Referring to message 202, the point of sale terminal 102 provides the relevant transaction information (as shown, card number and amount of purchase) to the customer card transaction processing system 104.

The customer card transaction processing system 104 comprises, for example and without limitation, a networked computer terminal and database including cardholder and/or card information associated with a plurality of cardholders. The cardholder and/or card information may include, for example, credit card number, cardholder name, expiration date, 3-digit security code, credit limits, balances or the like.

Historically, responsive to receiving relevant transaction information from the point of sale terminal 102, the customer card transaction processing system 104 verifies the validity of the card, determines available credit limit, balance or the like, compares the available credit limit, balance or the like to the charge amount and provides an approval status to the point of sale terminal 102. For example, the customer card transaction processing system 104 may inform the point of sale terminal 102 to accept the charge if the available credit limit, balance or the like equals or exceeds the charge amount, otherwise to reject the charge if the charge amount exceeds the available credit limit, balance or the like.

In embodiments of the present invention, the customer card transaction processing system 104 provides a cardholder verification code sequence to the point of sale terminal 102 (and additionally, may provide one or more of the historical functions of verifying the validity of the card, determining available credit limit, balance or the like, comparing the available credit limit, balance or the like to the charge amount and providing an approval status). As will be described in greater detail hereinafter, the point of sale terminal 102 uses the cardholder verification code sequence as a mechanism to confirm whether the customer is an authorized user of the card. The cardholder verification code sequence can be used alternatively or additionally to physical verification methods.

The customer card transaction processing system 104 initiates a request for a cardholder verification code sequence by providing relevant transaction information (as shown, card number) to the security code application server 106, via message 204; and the security code application server 106 provides the cardholder verification code sequence (“security code”) to the customer card transaction processing system 104 via message 206. Thereafter, the customer card transaction processing system 104 provides the cardholder verification code sequence and a conditional approval status (i.e., approval conditioned upon cardholder verification) to the point of sale terminal 102 via message 208.

As will be appreciated, to the extent the customer card transaction processing system 104 provides an approval status or any other of the above noted “historical” functions, the manner of implementation and/or timing of the functions relative to the cardholder verification code sequence may vary according to embodiments of the invention. As an example, the function of sending a cardholder verification code may be deferred subject to first verifying the validity of the card, determining available credit limit, balance or the like, comparing the available credit limit, balance or the like to the charge amount and providing conditional approval. Conversely, the functions of verifying the validity of the card, determining available credit limit, balance or the like, comparing the available credit limit, balance or the like to the charge amount and providing an approval status may be deferred subject to cardholder verification (i.e., not performed unless the cardholder is first verified using the cardholder verification code sequence).

The security code application server 106 includes a processor and memory (not shown) and is operable under control of the processor to dynamically generate cardholder verification code sequences, for purposes of cardholder verification corresponding to prospective customer card transactions. In one embodiment, the cardholder verification code sequence for each transaction comprises a random string of six alphanumeric characters. Alternatively or additionally, however, the cardholder verification code sequences may comprise different numbers of characters and may include, without limitation, numerical or alphanumeric sequences, text, symbols, images, audio or video content, may contain any amount of characters or content and may be generated in virtually any manner known or devised in the future.

In one embodiment, the cardholder verification code sequences do not include any customer card or transaction information that might enable the prospective customer to predict or derive the code sequence based on such information, but rather are uniquely derived for each transaction by the security code application server 106. Alternatively, the code sequences may incorporate some amount of customer card or transaction information, personal information, passwords or the like as long as such information does not enable the cardholder, person or device to predict or derive the code sequence. Advantageously, in either case, the cardholder verification code sequences will be sufficiently random so as to preclude prediction of the the sequence in advance by a person or device external to the security code application server 106.

The customer card-directory number mapping database 108 (hereinafter “customer database”) maintains customer card numbers or other suitable customer card information (for example, cardholder name, expiration date, 3-digit security code, credit limits, balances or the like) associated with a plurality of prospective customers, and the customer card number or information is indexed to a directory number of one or more customer units (e.g., mobile terminal, PDA or the like) associated with the prospective customers.

In one embodiment, responsive to receiving a card number associated with a customer card transaction from the customer card transaction processing system 104, the security code application server 106 consults the customer database 108 to determine the customer directory number corresponding to the card number. Thereafter, when the security code application server 106 generates a cardholder verification code sequence corresponding to the customer card transaction, it sends the code sequence to the customer unit 114 corresponding to the customer directory number in addition to the point of sale terminal 102.

As shown, the security code application server 106 is functionally linked to the customer unit 114 via an SMS gateway 110 and interconnecting network 112. In one embodiment, the security code application server 106 sends the code sequence and customer directory number to the SMS gateway, via message 210. The SMS gateway initiates an SMS message 212 including the code sequence; and the code sequence is carried via message 214 from the network 112 to the customer unit 114.

As will be appreciated, messaging modalities other than SMS may be used to communicate the code sequence to the customer unit 114, depending of course on the characteristics of the code sequence, customer unit, and the topology of the communication system 100. For example, messaging modalities including, without limitation, Multimedia Message Service (MMS), e-mail and voice communication could be used if supported by the communication system 100 and customer unit 114. The network 112 may represent a wireline network, an IP Multimedia Subsystem (IMS) network, a packet-based network (IP network), a wireless network, generally any type of network that is capable of supporting the messaging modality of the code sequence and customer unit 114.

In one embodiment, when the customer unit 114 receives the code sequence, it displays the code sequence such that it can be viewed by the customer and reported to the operator of the point of sale terminal (or in the case of an in-store transaction, the code sequence can be viewed directly by the operator of the point of sale terminal). Having received or viewed the code sequence relayed from the customer unit 114 and also from the security code application server 106, the operator compares the code sequences to verify whether the customer presenting the card is a valid user of the card. If the code sequences match, the customer is presumed valid and the transaction can be authorized (that is, presuming the charge amount does not exceed the available credit limit); otherwise if the code sequences do not match, the customer is presumed to be unauthorized.

Because a successful transaction requires both the card information and the security code obtained by the true cardholder's customer unit, unauthorized persons obtaining access to credit cards or their information can not accomplish a fraudulent purchase exclusively based on possession of the card or its information. They must also have possession of the true cardholder's customer unit at the time of the transaction which is unlikely. Even so, as a third layer of security, customer units can be password-locked, biometrically activated, or remotely deactivated, thus even in instances where a true cardholder's credit card and customer unit is lost or stolen, the customer unit will be unusable to an unauthorized person. Still further, the GPS capabilities inherent in some mobile customer units can act as a deterrent to unauthorized use, simply because it is possible to track such use by means of the GPS capabilities.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method, carried out by a customer unit, for purpose of cardholder verification associated with a customer card transaction, the method comprising steps of:
receiving a code sequence corresponding to the customer card transaction, the code sequence defining a customer unit code sequence;
using the customer unit code sequence for cardholder verification, whereby the customer unit code sequence is compared to a code sequence received independently by a point of sale terminal to determine an authorization status of the transaction.

2. The method of claim 1, wherein the step of receiving a code sequence comprises receiving an SMS message including the customer unit code sequence.

3. The method of claim 1, wherein the step of receiving a code sequence comprises receiving one of: an MMS, e-mail and voice message including the customer unit code sequence.

4. The method of claim 1, wherein the customer unit comprises a mobile terminal.

5. A cardholder verification method associated with a customer card transaction, the method comprising steps of:
receiving from a customer card processing system a first instance of code sequence corresponding to the customer card transaction;
receiving from a customer unit a second instance of code sequence corresponding to the customer card transaction; and
comparing the first and second instance of code sequence to determine an authorization status of the transaction.

6. The method of claim 5, performed by an operator of a point of sale terminal.

7. A method comprising:
receiving a card number associated with a customer card transaction;
generating a code sequence corresponding to a customer card transaction;
sending a first instance of the code sequence to a point of sale terminal; and
sending a second instance of the code sequence to a customer unit associated with the card number, wherein authorization status of the transaction is determined by comparing the first and second instances of the code sequence.

8. The method of claim 7, performed by an application server operably connected to the point of sale terminal and customer unit.
